(19) United States
(12) Patent Application Publication
(10) Pub. No.: US 2022/0126521 A1
(43) Pub. Date: Apr. 28, 2022

(54) Three-Dimensional Shaping Apparatus And Injection Molding Apparatus

(71) Applicant: Seiko Epson Corporation, Tokyo (JP)

(72) Inventors: Taki HASHIMOTO, Shiojiri (JP); Yasushi KUTSUWADA, Matsumoto (JP)

(21) Appl. No.: 17/505,728

(22) Filed: Oct. 20, 2021

(30) Foreign Application Priority Data
Oct. 22, 2020 (JP) 2020-177207

(51) Int. Cl. B29C 64/393; B29C 64/106; B29C 64/209; B29C 45/77; B29C 45/74; B29C 64/295; B33Y 30/00; B33Y 50/02

(52) U.S. Cl. CPC B29C 64/393; B29C 2945/76545; B29C 64/209; B29C 45/77; B29C 45/74; B29C 64/295; B33Y 30/00; B33Y 50/02; B29C 2945/76006; B29C 2945/7602; B29C 2945/7604; B29C 2945/76187; B29C 2945/7619; B29C 2945/76381; B29C 64/106

(57) ABSTRACT

A three-dimensional shaping apparatus includes a plasticizing unit, a nozzle, a stage, and a control unit, wherein the plasticizing unit includes a driving motor, a screw, a barrel, and a first heater that heats a material supplied between the screw and the barrel, and the control unit performs a process of decreasing an output of the first heater when at least one of a first condition, a second condition, and a third condition is satisfied, provided that the first condition is that a measurement value of a first temperature sensor that measures a temperature of the screw or the barrel is larger than a first predetermined value, the second condition is that a torque value of the driving motor is smaller than a second predetermined value, and the third condition is that a measurement value of a pressure sensor that measures a pressure in a flow channel between a communication hole and a nozzle opening is smaller than a third predetermined value.

The present application is based on, and claims priority from JP Application Serial Number 2020-177207, filed Oct. 22, 2020, the disclosure of which is hereby incorporated by reference herein in its entirety.

### BACKGROUND

### 1. Technical Field

The present disclosure relates to a three-dimensional shaping apparatus and an injection molding apparatus.

### 2. Related Art

There has been known a three-dimensional shaping apparatus that produces a three-dimensional shaped article by ejecting and stacking a plasticized shaping material, followed by hardening.

For example, JP-A-2010-241016 describes a plasticizing and sending-out device including a barrel in which a material inflow path is open to one end face, a rotor having an end face that is slidably in contact with the one end face of the barrel, and a spiral groove formed at the end face of the rotor. In the spiral groove, a material is supplied from a radially outer end portion, and also a radially inner end portion communicates with an opening end of the material inflow path.

In the plasticizing and sending-out device including the rotor as described above, a material can be stably plasticized by the balance between conveyance of the material and melting of the material. Ideally, it is desirable that in a material supply portion that is the radially outer end portion of the spiral groove, the material is in a solid state, and as the material approaches the radially inner end portion of the spiral groove, the material is transformed into a molten state. When the material is in a molten state in the supply portion, a conveyance force for conveying the material to the radially inner end portion cannot be obtained so that ejection is not stabilized, and also a bridge phenomenon in which a new material is not supplied occurs.

### SUMMARY

One aspect of a three-dimensional shaping apparatus according to the present disclosure includes a plasticizing unit that plasticizes a material to form a shaping material, a nozzle that has a nozzle opening and ejects the shaping material, a stage at which the shaping material ejected from the nozzle is stacked, and a control unit that controls the plasticizing unit. The plasticizing unit includes a driving motor, a screw that is rotated by the driving motor and that has a grooved face having a groove formed therein, a barrel that has an opposed face opposed to the grooved face and that is provided with a communication hole, and a first heater that heats the material supplied between the screw and the barrel. The control unit performs a process of decreasing an output of the first heater when at least one of a first condition, a second condition, and a third condition is satisfied, provided that the first condition is that a measurement value of a first temperature sensor that measures a temperature of the screw or the barrel is larger than a first predetermined value, the second condition is that a torque value of the driving motor is smaller than a second predetermined value, and the third condition is that a measurement value of a pressure sensor that measures a pressure in a flow channel between the communication hole and the nozzle opening is smaller than a third predetermined value.

One aspect of an injection molding apparatus according to the present disclosure includes a plasticizing unit that plasticizes a material to form a shaping material, a nozzle that has a nozzle opening and injects the shaping material supplied from the plasticizing unit to a mold, and a control unit that controls the plasticizing unit. The plasticizing unit includes a driving motor, a screw that is rotated by the driving motor and that has a grooved face having a groove formed therein, a barrel that has an opposed face opposed to the grooved face and that is provided with a communication hole, and a first heater that heats the material supplied between the screw and the barrel. The control unit performs a process of decreasing an output of the first heater when at least one of a first condition, a second condition, and a third condition is satisfied, provided that the first condition is that a measurement value of a first temperature sensor that measures a temperature of the screw or the barrel is larger than a first predetermined value, the second condition is that a torque value of the driving motor is smaller than a second predetermined value, and the third condition is that a measurement value of a pressure sensor that measures a pressure in a flow channel between the communication hole and the nozzle opening is smaller than a third predetermined value.

### BRIEF DESCRIPTION OF THE DRAWINGS

FIG. 1 is a cross-sectional view schematically showing a three-dimensional shaping apparatus according to the present embodiment.

FIG. 2 is a perspective view schematically showing a flat screw of the three-dimensional shaping apparatus according to the present embodiment.

FIG. 3 is a plan view schematically showing a barrel of the three-dimensional shaping apparatus according to the present embodiment.

FIG. 4 is a cross-sectional view schematically showing the barrel of the three-dimensional shaping apparatus according to the present embodiment.

FIG. 5 is a flowchart for illustrating a process of a control unit of the three-dimensional shaping apparatus according to the present embodiment.

FIG. 6 is a cross-sectional view schematically showing a three-dimensional shaping apparatus according to a first modification of the present embodiment.

FIG. 7 is a cross-sectional view schematically showing an injection molding apparatus according to the present embodiment.

FIG. 8 is a graph showing a relationship between a measurement time and a measurement value of a first temperature sensor.

### DESCRIPTION OF EXEMPLARY EMBODIMENTS

Hereinafter, preferred embodiments of the present disclosure will be described in detail using the drawings. Note that the embodiments described below are not intended to unduly limit the contents of the present disclosure described in the appended claims. Further, all the configurations described below are not necessarily essential configuration requirements of the present disclosure.

### 1. Three-Dimensional Shaping Apparatus

### 1.1. Overall Configuration

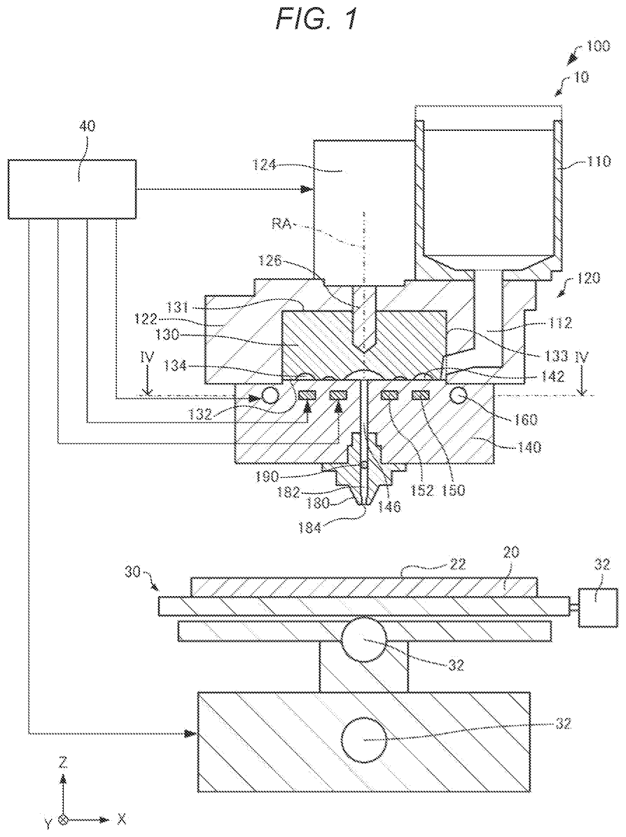

First, a three-dimensional shaping apparatus according to this embodiment will be described with reference to the drawings. FIG. 1 is a cross-sectional view schematically showing a three-dimensional shaping apparatus 100 according to the present embodiment. Note that in FIG. 1, as three axes orthogonal to one another, X axis, Y axis, and Z axis are shown. An X-axis direction and a Y-axis direction are each, for example, a horizontal direction. A Z-axis direction is, for example, a vertical direction.

The three-dimensional shaping apparatus 100 includes, for example, a shaping unit 10, a stage 20, a moving mechanism 30, and a control unit 40 as shown in FIG. 1.

The three-dimensional shaping apparatus 100 drives the moving mechanism 30 so as to change the relative position of a nozzle 180 and the stage 20 while ejecting a plasticized shaping material to the stage 20 from the nozzle 180 of the shaping unit 10. By doing this, the three-dimensional shaping apparatus 100 shapes a three-dimensional shaped article having a desired shape on the stage 20. The detailed configuration of the shaping unit 10 will be described later.

The stage 20 is moved by the moving mechanism 30. At a shaping face 22 of the stage 20, the shaping material ejected from the nozzle 180 is stacked, whereby the three-dimensional shaped article is formed.

The moving mechanism 30 changes the relative position of the shaping unit 10 and the stage 20. In the illustrated example, the moving mechanism 30 moves the stage 20 with respect to the shaping unit 10. The moving mechanism 30 is constituted by, for example, a three-axis positioner for moving the stage 20 in the X-axis direction, Y-axis direction, and Z-axis direction by the driving forces of three motors 32. The motors 32 are controlled by the control unit 40.

The moving mechanism 30 may be configured to move the shaping unit 10 without moving the stage 20. Alternatively, the moving mechanism 30 may be configured to move both the shaping unit 10 and the stage 20.

The control unit 40 is constituted by, for example, a computer including a processor, a main storage device, and an input/output interface for performing signal input/output to/from the outside. The control unit 40 exhibits various functions by, for example, execution of a program read in the main storage device by the processor. The control unit 40 controls the shaping unit 10 and the moving mechanism 30. A specific process of the control unit 40 will be described later. The control unit 40 may be constituted by a combination of multiple circuits instead of a computer.

### 1.2. Shaping Unit

The shaping unit 10 includes, for example, a material feeding unit 110, a plasticizing unit 120, the nozzle 180, and a pressure sensor 190 as shown in FIG. 1.

To the material feeding unit 110, a material in a pellet form or a powder form is fed. As the material to be fed to the material feeding unit 110, for example, an MIM (Metal Injection Molding) material containing metal particles and a thermoplastic resin is exemplified.

Examples of the material of the metal particles of the MIM material to be fed to the material feeding unit 110 include single metals of magnesium (Mg), iron (Fe), cobalt (Co), chromium (Cr), aluminum (Al), titanium (Ti), copper (Cu), and nickel (Ni), or alloys containing one or more of these metals, and a maraging steel, a stainless steel, cobalt-chromium-molybdenum, a titanium alloy, a nickel alloy, an aluminum alloy, a cobalt alloy, and a cobalt-chromium alloy.

Examples of the thermoplastic resin of the MIM material to be fed to the material feeding unit 110 include general-purpose engineering plastics such as polypropylene (PP), polyethylene (PE), polyacetal (POM), polyvinyl chloride (PVC), polyamide (PA), acrylonitrile-butadiene-styrene (ABS), polylactic acid (PLA), polyphenylene sulfide (PPS), polycarbonate (PC), modified polyphenylene ether, polybutylene terephthalate, and polyethylene terephthalate, and engineering plastics such as polysulfone, polyethersulfone, polyphenylene sulfide, polyarylate, polyimide, polyamideimide, polyetherimide, and polyether ether ketone (PEEK).

The material feeding unit 110 is constituted by, for example, a hopper. The material feeding unit 110 and the plasticizing unit 120 are coupled through a supply channel 112 provided below the material feeding unit 110. The material fed to the material feeding unit 110 is supplied to the plasticizing unit 120 through the supply channel 112.

The plasticizing unit 120 includes, for example, a screw case 122, a driving motor 124, a flat screw 130, a barrel 140, a first heater 150, a second heater 152, a chiller 160, a first temperature sensor 170, and a second temperature sensor 172. The plasticizing unit 120 plasticizes a material in a solid state supplied from the material feeding unit 110 so as to form a shaping material in a paste form having fluidity, and supplies the shaping material to the nozzle 180.

Note that the “plasticization” is a concept including melting, and refers to transformation into a state having fluidity from a solid. Specifically, in a case of a material in which glass transition occurs, the “plasticization” is to raise the temperature of the material to a temperature equal to or higher than the glass transition point. In a case of a material in which glass transition does not occur, the “plasticization” is to raise the temperature of the material to a temperature equal to or higher than the melting point.

The screw case 122 is a housing that houses the flat screw 130. At a lower face of the screw case 122, the barrel 140 is provided. The flat screw 130 is housed in a space surrounded by the screw case 122 and the barrel 140.

The driving motor 124 is provided at an upper face of the screw case 122. The driving motor 124 is, for example, a servomotor. A shaft 126 of the driving motor 124 is coupled to an upper face 131 of the flat screw 130. The driving motor 124 is controlled by the control unit 40.

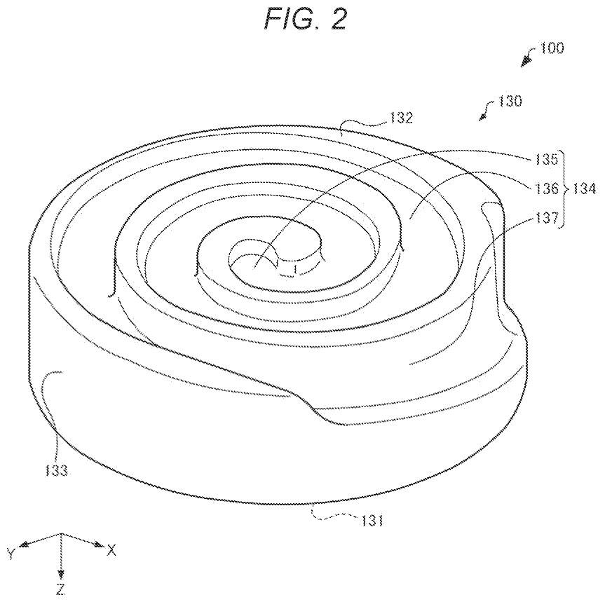

The flat screw 130 has a substantially columnar shape in which a size in a direction of a rotational axis RA is smaller than a size in a direction orthogonal to the direction of the rotational axis RA. In the illustrated example, the rotational axis RA is parallel to the Z axis. The flat screw 130 is rotated around the rotational axis RA by a torque generated by the driving motor 124. The flat screw 130 has an upper face 131, a grooved face 132 at an opposite side to the upper face 131, and a side face 133 that couples the upper face 131 to the grooved face 132. The grooved face 132 is provided with a first groove 134. Here, FIG. 2 is a perspective view schematically showing the flat screw 130. Note that FIG. 2 shows a state in which the up-and-down positional relationship is reversed to that of the state shown in FIG. 1 for the sake of convenience. Further, in FIG. 1, the flat screw 130 is shown in a simplified manner.

In the grooved face 132 of the flat screw 130, the first groove 134 is provided as shown in FIG. 2. The first groove 134 includes, for example, a central portion 135, a groove coupling portion 136, and a material introduction portion 137. The central portion 135 is opposed to a communication hole 146 provided in the barrel 140. The central portion 135 communicates with the communication hole 146. The groove coupling portion 136 couples the central portion 135 to the material introduction portion 137. In the illustrated example, the groove coupling portion 136 is provided in a spiral shape from the central portion 135 toward the outer circumference of the grooved face 132. The material introduction portion 137 is provided at the outer circumference of the grooved face 132. That is, the material introduction portion 137 is provided at the side face 133 of the flat screw 130. The material supplied from the material feeding unit 110 is introduced into the first groove 134 from the material introduction portion 137, passes through the groove coupling portion 136 and the central portion 135, and is conveyed to the communication hole 146 provided in the barrel 140. The number of first grooves 134 is not particularly limited and two or more first grooves 134 may be provided.

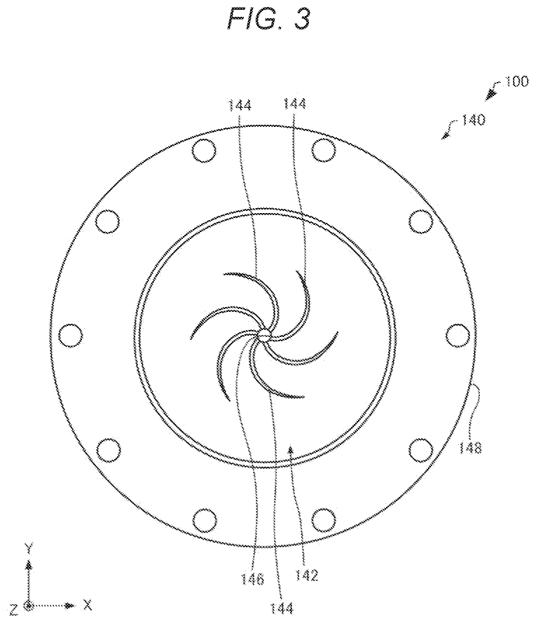

The barrel 140 is provided below the flat screw 130 as shown in FIG. 1. The barrel 140 has an opposed face 142 opposed to the grooved face 132 of the flat screw 130. At the center of the opposed face 142, the communication hole 146 that communicates with the first groove 134 is provided. Here, FIG. 3 is a plan view schematically showing the barrel 140. Note that in FIG. 1, the barrel 140 is shown in a simplified manner for the sake of convenience.

In the opposed face 142 of the barrel 140, a second groove 144 and the communication hole 146 are provided as shown in FIG. 3. Multiple second grooves 144 are provided. In the illustrated example, six second grooves 144 are provided, but the number thereof is not particularly limited. The multiple second grooves 144 are provided around the communication hole 146 in plan view. In the illustrated example, the plan view is a view seen from the Z-axis direction. One end of the second groove 144 is coupled to the communication hole 146, and the second groove 144 extends in a spiral shape toward an outer circumference 148 of the barrel 140 from the communication hole 146. The second groove 144 has a function of guiding the shaping material to the communication hole 146.

The shape of the second groove 144 is not particularly limited, and may be, for example, a linear shape. Further, one end of the second groove 144 need not be coupled to the communication hole 146. In addition, the second groove 144 need not be provided in the opposed face 142. However, when taking into consideration that the shaping material is efficiently guided to the communication hole 146, the second groove 144 is preferably provided in the opposed face 142.

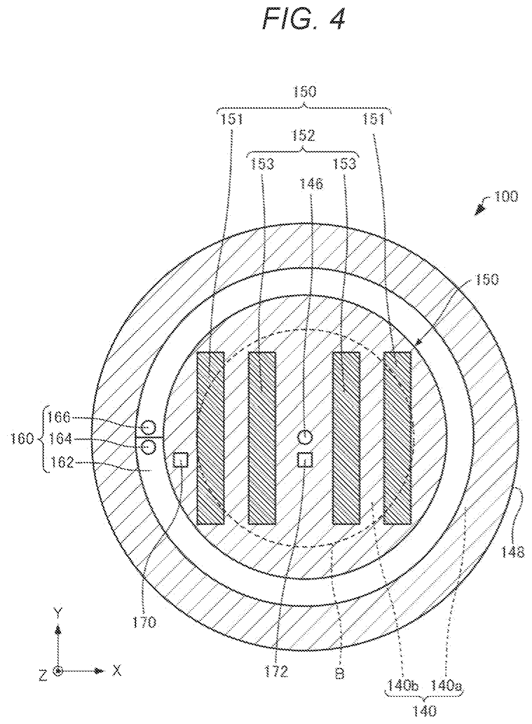

The first heater 150 and the second heater 152 are provided in the barrel 140 as shown in FIG. 1. The heaters 150 and 152 heat the material supplied between the flat screw 130 and the barrel 140. The heaters 150 and 152 are controlled by the control unit 40. Here, FIG. 4 is a cross-sectional view taken along the line IV-IV of FIG. 1 schematically showing the three-dimensional shaping apparatus 100.

The first heater 150 is constituted by a pair of bar heaters 151 as shown in FIG. 4. The second heater 152 is provided between the pair of bar heaters 151. The second heater 152 is constituted by a pair of bar heaters 153. The communication hole 146 is provided between the pair of bar heaters 153. The second heater 152 is provided nearer to the communication hole 146 than the first heater 150. That is, a distance between the second heater 152 and the communication hole 146 is smaller than a distance between the first heater 150 and the communication hole 146. The control unit 40 controls the heaters 150 and 152 so that the temperature of the second heater 152 is higher than the temperature of the first heater 150. The bar heaters 151 and 153 each may be a ceramic heater or an electric heating wire heater.

Although not illustrated, the second heater 152 need not be provided. Further, a third heater may be provided in addition to the first heater 150 and the second heater 152.

The chiller 160 is provided in the barrel 140. The chiller 160 includes, for example, a cooling flow channel 162, an inlet 164, and an outlet 166. In the illustrated example, the cooling flow channel 162 is provided along the outer circumference 148 of the barrel 140. The cooling flow channel 162 is provided so as to surround the communication hole 146 and the heaters 150 and 152 in plan view. The chiller 160 cools the material supplied to the first groove 134 from the material feeding unit 110. By the heaters 150 and 152 and the chiller 160, a temperature gradient is formed such that the temperature gradually increases from the outer circumference 148 of the barrel 140 to the communication hole 146.

Into the cooling flow channel 162, a refrigerant is introduced from the inlet 164. The refrigerant introduced from the inlet 164 flows through the cooling flow channel 162 and is discharged from the outlet 166. The chiller 160 circulates the refrigerant from the outlet 166 to the inlet 164 while cooling the refrigerant. Examples of the refrigerant include water and industrial water.

A place where the heaters 150 and 152 and the chiller 160 are provided is not particularly limited. Although not illustrated, the heaters 150 and 152 and the chiller 160 may be provided in the screw case 122 or in the flat screw 130.

The first temperature sensor 170 and the second temperature sensor 172 are provided in the barrel 140. The temperature sensors 170 and 172 measure the temperature of the barrel 140. The temperature sensors 170 and 172 are each, for example, a thermocouple, a thermistor, an infrared sensor, or the like.

The first temperature sensor 170 is provided in an outer region 140a of the barrel 140. The first temperature sensor 170 measures the temperature of the outer region 140a. The outer region 140a is a region nearer to the outer circumference 148 of the barrel 140 than to the communication hole 146. The second temperature sensor 172 is provided in an inner region 140b of the barrel 140. The second temperature sensor 172 measures the temperature of the inner region 140b. The inner region 140b is a region nearer to the communication hole 146 than to the outer circumference 148 of the barrel 140. A distance from a boundary B between the outer region 140a and the inner region 140b to the communication hole 146 and a distance from the boundary B to the outer circumference 148 are equal to each other.

The first temperature sensor 170 is provided outside the first heater 150. That is, the first temperature sensor 170 is not provided between the pair of bar heaters 151 constituting the first heater 150. The second temperature sensor 172 is provided inside the second heater 152. That is, the second temperature sensor 172 is provided between the pair of bar heaters 153 constituting the second heater 152. The control unit 40 controls the first heater 150 based on the measurement value of the first temperature sensor 170. The control unit 40 controls the second heater 152 based on the measurement value of the second temperature sensor 172.

Although not illustrated, the temperature sensors 170 and 172 may be provided in the flat screw 130 and measure the temperature of the flat screw 130. Further, the second temperature sensor 172 need not be provided. Further, a third temperature sensor may be provided in addition to the first temperature sensor 170 and the second temperature sensor 172.

The nozzle 180 is provided below the barrel 140. The nozzle 180 ejects the shaping material supplied from the plasticizing unit 120 toward the stage 20. In the nozzle 180, a nozzle flow channel 182 and a nozzle hole 184 are provided. The nozzle flow channel 182 communicates with the communication hole 146. The nozzle hole 184 communicates with the nozzle flow channel 182. The nozzle hole 184 is also referred to as a nozzle opening and is an opening provided at a tip of the nozzle 180. The planar shape of the nozzle hole 184 is, for example, a circular shape. The shaping material supplied to the nozzle flow channel 182 from the communication hole 146 is ejected from the nozzle hole 184.

The pressure sensor 190 is provided in the nozzle 180 as shown in FIG. 1. The pressure sensor 190 measures the pressure in the nozzle 180. In the illustrated example, the pressure sensor 190 is provided in the nozzle flow channel 182 and measures the pressure in the nozzle flow channel 182. The pressure sensor 190 may be configured to measure the pressure in the flow channel between the communication hole 146 and the nozzle hole 184, and the pressure sensor 190 may be provided in the communication hole 146 or in the nozzle flow channel 182.

### 1.3. Control Unit

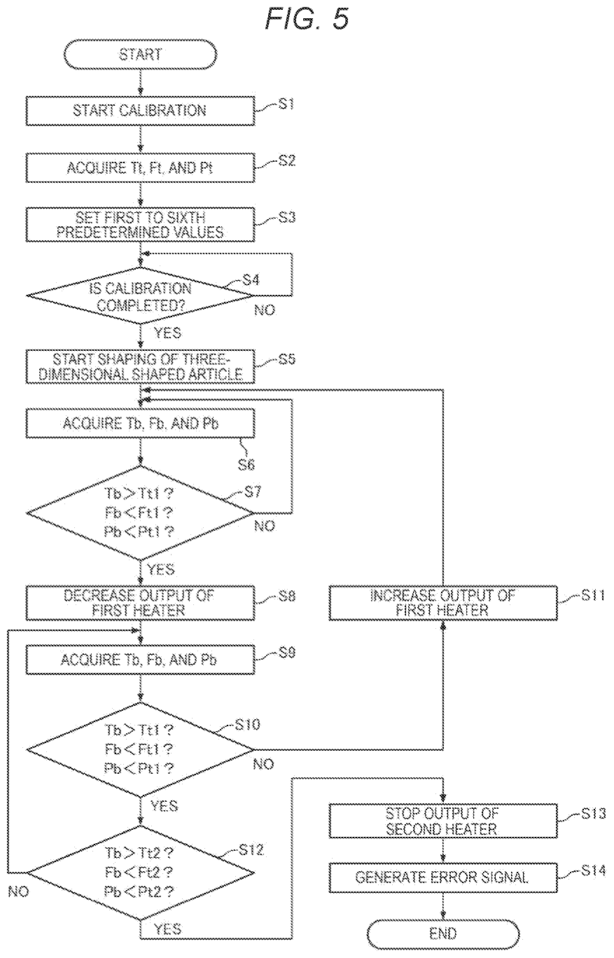

The control unit 40 controls the plasticizing unit 120. Specifically, the control unit 40 controls the driving motor 124 and the heaters 150 and 152. FIG. 5 is a flowchart for illustrating a process of the control unit 40.

A user, for example, operates an unillustrated operation unit to cause the operation unit to output a process start signal for starting the process to the control unit 40. The operation unit is realized by, for example, a mouse, a keyboard, a touch panel, or the like. The control unit 40 starts the process when receiving the process start signal.

As shown in FIG. 5, the control unit 40 performs a process of starting calibration of the line width of the shaping material as Step S1. Specifically, the control unit 40 drives the plasticizing unit 120 and the moving mechanism 30 to eject the shaping material from the nozzle 180 and starts calibration of the line width of the shaping material ejected at the stage 20. In the calibration, the control unit 40 acquires the line width of the shaping material from, for example, an unillustrated sensor, and controls the driving motor 124 so that the acquired line width becomes a preset set value. The set value is stored in, for example, an unillustrated memory portion. The memory portion is realized by, for example, RAM (Random Access Memory).

Subsequently, the control unit 40 performs a process of acquiring a measurement value Tt of the first temperature sensor 170, a torque value Ft of the driving motor 124, and a measurement value Pt of the pressure sensor 190 as Step S2. Tt, Ft, and Pt are acquired during the process of calibration. The order of acquiring Tt, Ft, and Pt is not particularly limited.

Subsequently, the control unit 40 performs a process of setting a first predetermined value, a second predetermined value, and a third predetermined value as Step S3. The first predetermined value, the second predetermined value, and the third predetermined value are values to become first threshold values of the measurement value of the first temperature sensor 170, the torque value of the driving motor 124, and the measurement value of the pressure sensor 190, respectively.

Further, the control unit 40 performs a process of setting a fourth predetermined value, a fifth predetermined value, and a sixth predetermined value. The fourth predetermined value is a larger value than the first predetermined value. The fifth predetermined value is a smaller value than the second predetermined value. The sixth predetermined value is a smaller value than the third predetermined value. The fourth predetermined value, the fifth predetermined value, and the sixth predetermined value are values to become second threshold values of the measurement value of the first temperature sensor 170, the torque value of the driving motor 124, and the measurement value of the pressure sensor 190, respectively.

The control unit 40 sets the first to sixth predetermined values based on, for example, information regarding the type of material included in the process start signal, and Tt, Ft, and Pt acquired in Step S2. The first to sixth predetermined values vary depending on the type of material to be fed to the material feeding unit 110. For example, in the memory portion, a table that associates the type of material with the first to sixth predetermined values is recorded, and the control unit 40 sets the first to sixth predetermined values based on the information regarding the type of material included in the process start signal and the table.

Subsequently, the control unit 40 performs a process of determining whether or not the calibration of the line width of the shaping material is completed as Step S4. When it is determined that the acquired line width is not the set value, the control unit 40 determines that the calibration is not completed (“NO” in Step S4) and repeats the process of calibration until the acquired line width becomes the set value. On the other hand, when it is determined that the acquired line width is the predetermined value, the control unit 40 determines that the calibration is completed (“YES” in Step S4) and allows the process to proceed to Step S5.

In Step S5, the control unit 40 performs a process of starting shaping of a three-dimensional shaped article. Specifically, the control unit 40 drives the plasticizing unit 120 and the moving mechanism 30 to eject the shaping material from the nozzle 180 and starts shaping of a three-dimensional shaped article based on shaping data for shaping the three-dimensional shaped article. The shaping data are generated by, for example, slicer software installed on the computer coupled to the three-dimensional shaping apparatus 100. The control unit 40 acquires the shaping data from the computer coupled to the three-dimensional shaping apparatus 100 or a recording medium such as a USB (Universal Serial Bus) memory.

Subsequently, the control unit 40 performs a process of acquiring a measurement value Tb of the first temperature sensor 170, a torque value Fb of the driving motor 124, and a measurement value Pb of the pressure sensor 190 as Step S6. Tb, Fb, and Pb are acquired during the shaping process of the three-dimensional shaped article. The order of acquiring Tb, Fb, and Pb is not particularly limited.

Subsequently, the control unit 40 performs a process of determining whether or not at least one of a first condition, a second condition, and a third condition is satisfied as Step S7. The first to third conditions are as follows.

First condition: the measurement value Tb of the first temperature sensor 170 is larger than a first predetermined value Tt1

Second condition: the torque value Fb of the driving motor 124 is smaller than a second predetermined value Ft1

Third condition: the measurement value Pb of the pressure sensor 190 is smaller than a third predetermined value Pt1

In the first to third conditions, the predetermined values Tt1, Ft1, and Pt1 are values set in Step S3. When the material to be fed to the material feeding unit 110 is MIM, for example, Tt acquired in Step S2 is 70° C., and Tt1 is 75° C. resulting from adding 5° C. to 70° C.

When it is determined that none of the first condition, the second condition, and the third condition are satisfied (“NO” in Step S7), the control unit 40 returns the process to Step S6 and performs the process of acquiring Tb, Fb, and Pb. On the other hand, when it is determined that at least one of the first condition, the second condition, and the third condition is satisfied (“YES” in Step S7), the control unit 40 allows the process to proceed to Step S8.

In Step S8, the control unit 40 performs a process of decreasing the output of the first heater 150. In the process, the control unit 40 may stop the output of the first heater 150 by decreasing the output value of the first heater 150 to 0.

Subsequently, the control unit 40 performs a process of acquiring the measurement value Tb of the first temperature sensor 170, the torque value Fb of the driving motor 124, and the measurement value Pb of the pressure sensor 190 as Step S9. The order of acquiring Tb, Fb, and Pb is not particularly limited.

Subsequently, the control unit 40 performs a process of determining whether or not at least one of the first condition, the second condition, and the third condition is satisfied as Step S10. When it is determined that none of the first condition, the second condition, and the third condition are satisfied (“NO” in Step S10), the control unit 40 allows the process to proceed to Step S11. For example, even if the first condition is satisfied in Step S7, there is a case where the first condition is not satisfied in Step S10 by decreasing the output of the first heater 150 in Step S8.

In Step S11, the control unit 40 performs a process of increasing the output of the first heater 150 to a predetermined value. When the output of the first heater 150 is stopped in Step S8, the control unit 40 starts the first heater 150 and increases the output of the first heater 150 to a predetermined value. Thereafter, the control unit 40 returns the process to Step S6 and performs the process of acquiring Tb, Fb, and Pb.

On the other hand, when it is determined that at least one of the first condition, the second condition, and the third condition is satisfied in Step S10 (“YES” in Step S10), the control unit 40 allows the process to proceed to Step S12.

In Step S12, the control unit 40 performs a process of determining whether or not at least one of a fourth condition, a fifth condition, and a sixth condition is satisfied. The fourth to sixth conditions are as follows.

Fourth condition: the measurement value Tb of the first temperature sensor 170 is larger than a fourth predetermined value Tt2

Fifth condition: the torque value Fb of the driving motor 124 is smaller than a fifth predetermined value Ft2

Sixth condition: the measurement value Pb of the pressure sensor 190 is smaller than a sixth predetermined value Pt2

In the fourth to sixth conditions, the predetermined values Tt2, Ft2, and Pt2 are values set in Step S3. The fourth predetermined value Tt2 is a larger value than the first predetermined value Tt1, and when the material is MIM, for example, Tt acquired in Step S2 is 70° C., and Tt2 is 80° C. resulting from adding 10° C. to 70° C. The fifth predetermined value Ft2 is a smaller value than the second predetermined value Ft1. The sixth predetermined value Pt2 is a smaller value than the third predetermined value Pt1.

When it is determined that none of the fourth condition, the fifth condition, and the sixth condition are satisfied (“NO” in Step S12), the control unit 40 returns the process to Step S9 and performs the process of acquiring Tb, Fb, and Pb. On the other hand, when it is determined that at least one of the fourth condition, the fifth condition, and the sixth condition is satisfied (“YES” in Step S12), the control unit 40 allows the process to proceed to Step S13.

In Step S13, the control unit 40 performs a process of stopping the output of the second heater 152. Note that even if the output of the second heater 152 is stopped, the output of the chiller 160 is not stopped. If the output of the chiller 160 is stopped, when the chiller 160 has a seal ring composed of rubber, the seal ring is melted by heat. When the seal ring is melted, a water leak occurs. Therefore, the chiller 160 is kept driven.

Subsequently, the control unit 40 stops the output of the driving motor 124 and performs a process of generating an error signal as Step S14. The error signal is a signal for notifying a user that the material is melted in the material introduction portion 137 of the first groove 134 provided in the flat screw 130, that is, the material supplied between the flat screw 130 and the barrel 140 is all melted. The control unit 40 outputs the error signal to an unillustrated display portion and displays error information on the display portion. According to this, the three-dimensional shaping apparatus 100 can notify a user of the error information. The display portion is realized by, for example, a liquid crystal display.

The three-dimensional shaping apparatus 100 may notify a user of the error information through sound or vibration. Further, the order of Step S13 and Step S14 is not particularly limited.

Thereafter, the control unit 40 terminates the process.

### 1.4. Operational Effects

In the three-dimensional shaping apparatus 100, the control unit 40 performs the process of decreasing the output of the first heater 150 when at least one of the first condition, the second condition, and the third condition is satisfied. Therefore, in the three-dimensional shaping apparatus 100, the temperature between the flat screw 130 and the barrel 140 can be decreased as compared to a case where the output of the first heater is not decreased even if at least one of the first condition, the second condition, and the third condition is satisfied. According to this, melting of all the material supplied between the flat screw 130 and the barrel 140 (full melting) can be suppressed. As a result, a bridge phenomenon is suppressed, and stable plasticization can be achieved.

For example, a fact that the measurement value of the first temperature sensor 170 is larger than the first predetermined value as the first condition indicates that the temperature of the material is high, and therefore, there is a possibility of full melting. A fact that the torque value of the driving motor 124 is smaller than the second predetermined value as the second condition indicates that the viscosity of the material is small due to melting of the material, and therefore, there is a possibility of full melting. A fact that the measurement value of the pressure sensor 190 is smaller than the third predetermined value as the third condition indicates that the shaping material is not supplied to the communication hole 146 due to melting of the material, and therefore, there is a possibility of full melting.

In the three-dimensional shaping apparatus 100, the control unit 40 stops the output of the first heater 150 in the process of decreasing the output of the first heater 150. Therefore, in the three-dimensional shaping apparatus 100, the temperature between the flat screw 130 and the barrel 140 can be further decreased.

In the three-dimensional shaping apparatus 100, the plasticizing unit 120 includes the second heater 152 provided nearer to the communication hole 146 than the first heater 150. Therefore, in the three-dimensional shaping apparatus 100, even if the output of the first heater 150 is decreased, the temperature in the vicinity of the communication hole 146 can be kept high by the second heater 152.

In the three-dimensional shaping apparatus 100, after performing the process of decreasing the output of the first heater 150, the control unit 40 performs the process of stopping the output of the second heater 152 when at least one of the fourth condition, the fifth condition, and the sixth condition is satisfied. Therefore, in the three-dimensional shaping apparatus 100, the temperature between the flat screw 130 and the barrel 140 can be further decreased.

In the three-dimensional shaping apparatus 100, when at least one of the fourth condition, the fifth condition, and the sixth condition is satisfied, the output of the driving motor 124 is stopped, and the process of generating an error signal is performed. Therefore, in the three-dimensional shaping apparatus 100, a user can be notified that an error has occurred while reducing the amount of the material to be wasted.

In the three-dimensional shaping apparatus 100, the first temperature sensor 170 measures the temperature of the outer region 140a nearer to the outer circumference 148 of the barrel 140 than to the communication hole 146. Therefore, in the three-dimensional shaping apparatus 100, by monitoring the temperature measured with the first temperature sensor 170, the material can be prevented from being melted in the outer region 140a of the barrel 140.

In the three-dimensional shaping apparatus 100, the plasticizing unit 120 includes the second temperature sensor 172 that measures the temperature of the inner region 140b nearer to the communication hole 146 than to the outer circumference 148 of the barrel 140, and the control unit 40 controls the first heater 150 based on the measurement value of the first temperature sensor 170 and controls the second heater 152 based on the measurement value of the second temperature sensor 172. Therefore, in the three-dimensional shaping apparatus 100, the control unit 40 can independently control the first heater 150 and the second heater 152.

In the three-dimensional shaping apparatus 100, the first temperature sensor 170 is provided outside the first heater 150, and the second temperature sensor 172 is provided inside the second heater 152. Therefore, in the three-dimensional shaping apparatus 100, for example, as compared to a case where both the temperature sensors are provided outside the first heater or a case where both the temperature sensors are provided inside the second heater, the effect of the second heater 152 on the first temperature sensor 170 and the effect of the first heater 150 on the second temperature sensor 172 can be decreased.

In the three-dimensional shaping apparatus 100, the first predetermined value, the second predetermined value, and the third predetermined value vary depending on the type of the material. Therefore, in the three-dimensional shaping apparatus 100, optimal values can be set for each material as the first to third predetermined values.

In the material to be fed to the material feeding unit 110, a ceramic material may be mixed in addition to the metal particles and the thermoplastic resin. Examples of the ceramic material include oxide ceramics such as silicon dioxide, titanium dioxide, aluminum oxide, and zirconium oxide, and non-oxide ceramics such as aluminum nitride. Further, in the material, for example, an additive such as a pigment, a wax, a flame retardant, an antioxidant, or a heat stabilizer, or the like may be mixed.

In addition, to the material to be fed to the material feeding unit 110, a binder may be added. Examples of the binder include an acrylic resin, an epoxy resin, a silicone resin, a cellulosic resin, or another synthetic resin, or PLA (polylactic acid), PA (polyamide), PPS (polyphenylene sulfide), and PEEK (polyether ether ketone).

Further, in the above example, as the screw, the flat screw 130 in which the size in the direction of the rotational axis RA is smaller than the size in the direction orthogonal to the direction of the rotational axis RA is used, however, a bar-shaped in-line screw which is long in the direction of the rotational axis RA may be used in place of the flat screw 130.

### 2. Modifications of Three-Dimensional Shaping Apparatus

### 2.1. First Modification

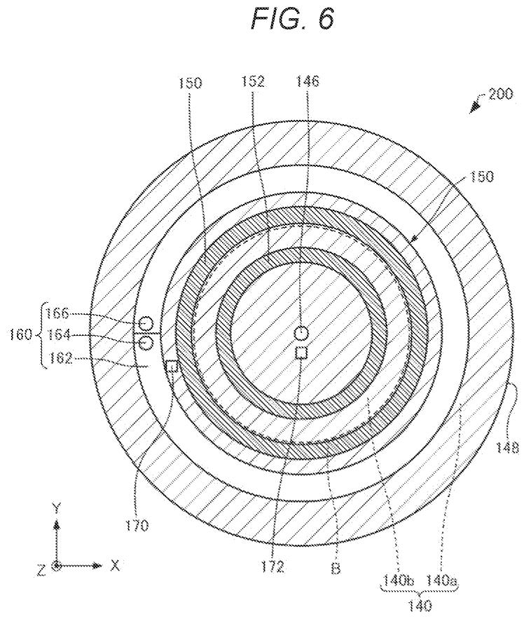

Next, a three-dimensional shaping apparatus according to a first modification of the present embodiment will be described with reference to the drawing. FIG. 6 is a cross-sectional view schematically showing the barrel 140 of a three-dimensional shaping apparatus 200 according to a first modification of the present embodiment.

Hereinafter, in the three-dimensional shaping apparatus 200 according to the first modification of the present embodiment, members having the same function as the constituent members of the three-dimensional shaping apparatus 100 according to the present embodiment described above are denoted by the same reference numerals, and a detailed description thereof is omitted. The same also applies to a three-dimensional shaping apparatus according to a second modification of the present embodiment described below.

In the three-dimensional shaping apparatus 100, as shown in FIG. 4, the first heater 150 is constituted by the pair of bar heaters 151 and the second heater 152 is constituted by the pair of bar heaters 153.

On the other hand, in the three-dimensional shaping apparatus 200, as shown in FIG. 6, the first heater 150 and the second heater 152 are each a ring heater. The heaters 150 and 152 each have a shape surrounding the communication hole 146 in plan view. In the illustrated example, the first heater 150 surrounds the second heater 152. The second heater 152 surrounds the communication hole 146. The first heater 150 is, for example, provided in the outer region 140a of the barrel 140. The second heater 152 is, for example, provided in the inner region 140b of the barrel 140. The first temperature sensor 170 is provided outside the first heater 150. The second temperature sensor 172 is provided inside the second heater 152.

In the three-dimensional shaping apparatus 200, the first heater 150 and the second heater 152 each have a shape surrounding the communication hole 146, and therefore, for example, as compared to a case where the first heater and the second heater are each constituted by a bar-shaped heater, a temperature gradient such that the temperature gradually increases from the outer circumference 148 of the barrel 140 to the communication hole 146 can be easily formed.

The heaters 150 and 152 are not limited to the ring heaters as long as the heaters have a shape surrounding the communication hole 146. Although not illustrated, the heaters 150 and 152 may have a polygonal shape.

### 2.2. Second Modification

Next, a three-dimensional shaping apparatus according to the second modification of the present embodiment will be described. In the three-dimensional shaping apparatus 100 described above, as the material for shaping the three-dimensional shaped article, MIM is used.

On the other hand, in the three-dimensional shaping apparatus according to the second modification of the present embodiment, as the material for shaping the three-dimensional shaped article, a material other than MIM, for example, a material containing any of various materials such as a material having thermoplasticity, a metal material, and a ceramic material as a main material can be exemplified. Here, the “main material” means a material serving as a main component for forming the shape of the three-dimensional shaped article and refers to a material whose content ratio is 50 mass % or more in the three-dimensional shaped article. In the above-mentioned material, a material obtained by melting such a main material singly, and a material formed into a paste by melting some components contained together with the main material are included.

As the material having thermoplasticity, for example, a thermoplastic resin can be used. Examples of the thermoplastic resin include general-purpose engineering plastics such as polypropylene (PP), polyethylene (PE), polyacetal (POM), polyvinyl chloride (PVC), polyamide (PA), acrylonitrile-butadiene-styrene (ABS), polylactic acid (PLA), polyphenylene sulfide (PPS), polycarbonate (PC), modified polyphenylene ether, polybutylene terephthalate, and polyethylene terephthalate, and engineering plastics such as polysulfone, polyethersulfone, polyphenylene sulfide, polyarylate, polyimide, polyamideimide, polyetherimide, and polyether ether ketone (PEEK).

In the material having thermoplasticity, a pigment, a metal, a ceramic, or other than these, an additive such as a wax, a flame retardant, an antioxidant, or a heat stabilizer, or the like may be mixed. The material having thermoplasticity is plasticized and converted into a molten state by rotation of the flat screw 130 and heating by the heaters 150 and 152 in the plasticizing unit 120. The shaping material formed in this manner is hardened by lowering the temperature after being ejected from the nozzle 180. The material having thermoplasticity is desirably ejected from the nozzle 180 in a completely molten state by being heated to a temperature equal to or higher than the glass transition point thereof.

In the plasticizing unit 120, in place of the above-mentioned material having thermoplasticity, for example, a metal material may be used as the main material. In that case, it is desirable that a component that melts when forming the shaping material is mixed in a powder material obtained by pulverizing the metal material into a powder, and the resulting material is fed to the plasticizing unit 120.

Examples of the metal material include single metals of magnesium (Mg), iron (Fe), cobalt (Co), chromium (Cr), aluminum (Al), titanium (Ti), copper (Cu), and nickel (Ni), or alloys containing one or more of these metals, and a maraging steel, a stainless steel, cobalt-chromium-molybdenum, a titanium alloy, a nickel alloy, an aluminum alloy, a cobalt alloy, and a cobalt-chromium alloy.

In the plasticizing unit 120, in place of the above-mentioned metal material, a ceramic material can be used as the main material. Examples of the ceramic material include oxide ceramics such as silicon dioxide, titanium dioxide, aluminum oxide, and zirconium oxide, and non-oxide ceramics such as aluminum nitride.

The powder material of the metal material or the ceramic material to be fed to the material feeding unit 110 may be a mixed material obtained by mixing multiple types of single metal powders or alloy powders or ceramic material powders. Further, the powder material of the metal material or the ceramic material may be coated with, for example, any of the above-mentioned thermoplastic resins or any other thermoplastic resin. In that case, the material may be configured to exhibit fluidity by melting the thermoplastic resin in the plasticizing unit 120.

To the powder material of the metal material or the ceramic material to be fed to the material feeding unit 110, for example, a solvent can also be added. Examples of the solvent include water; (poly)alkylene glycol monoalkyl ethers such as ethylene glycol monomethyl ether, ethylene glycol monoethyl ether, propylene glycol monomethyl ether, and propylene glycol monoethyl ether; acetate esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl n-butyl ketone, diisopropyl ketone, and acetyl acetone; alcohols such as ethanol, propanol, and butanol; tetra-alkyl ammonium acetates; sulfoxide-based solvents such as dimethyl sulfoxide and diethyl sulfoxide; pyridine-based solvents such as pyridine, γ-picoline, and 2,6-lutidine; tetra-alkyl ammonium acetates (for example, tetra-butyl ammonium acetate, etc.); and ionic liquids such as butyl carbitol acetate.

### 3. Injection Molding Apparatus

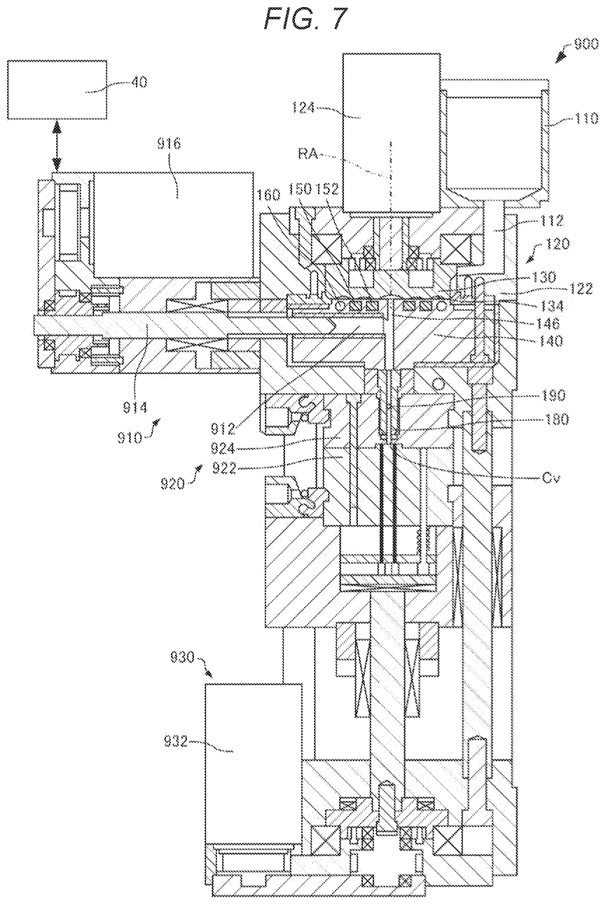

Next, an injection molding apparatus according to the present embodiment will be described with reference to the drawing. FIG. 7 is a cross-sectional view schematically showing an injection molding apparatus 900 according to the present embodiment.

The injection molding apparatus 900 includes, for example, a material feeding unit 110, a plasticizing unit 120, a nozzle 180, a pressure sensor 190, an injection mechanism 910, a mold portion 920, and a mold clamping device 930 as shown in FIG. 7. The plasticizing unit 120 includes a screw case 122, a driving motor 124, a flat screw 130, a barrel 140, a first heater 150, a second heater 152, a chiller 160, a first temperature sensor 170, and a second temperature sensor 172. Note that in FIG. 7, the first temperature sensor 170 and the second temperature sensor 172 are not shown for the sake of convenience.

The plasticizing unit 120 plasticizes a material supplied to a first groove 134 of the flat screw 130 to form a shaping material in a paste form having fluidity, and guides the shaping material to the injection mechanism 910 from a communication hole 146.

The injection mechanism 910 includes an injection cylinder 912, a plunger 914, and a plunger driving unit 916. The injection mechanism 910 has a function of injecting the shaping material in the injection cylinder 912 into a cavity Cv. The control unit 40 controls an injection amount of the shaping material from the nozzle 180. The injection cylinder 912 is a member in a substantially cylindrical shape coupled to the communication hole 146 of the barrel 140. The plunger 914 slides inside the injection cylinder 912, and pressure-feeds the shaping material in the injection cylinder 912 to the nozzle 180 coupled to the plasticizing unit 120. The plunger 914 is driven by the plunger driving unit 916 constituted by a motor.

The mold portion 920 includes a movable mold 922 and a fixed mold 924. The movable mold 922 and the fixed mold 924 are provided opposed to each other. Between the movable mold 922 and the fixed mold 924, the cavity Cv that is a space corresponding to the shape of a molded article is provided. The shaping material is pressure-fed to the cavity Cv by the injection mechanism 910. The nozzle 180 ejects the shaping material to the mold portion 920.

The mold clamping device 930 includes a mold driving unit 932. The mold driving unit 932 has a function of opening and closing the movable mold 922 and the fixed mold 924. The mold clamping device 930 drives the mold driving unit 932 so as to move the movable mold 922 to open and close the mold portion 920.

### 4. Experimental Example

The measurement value of the first temperature sensor was evaluated using a three-dimensional shaping apparatus corresponding to the above-mentioned three-dimensional shaping apparatus 100. Specifically, the measurement value of the first temperature sensor was evaluated when the first heater was driven (first heater was on) and when the output of the first heater was stopped (first heater was off) in a state where the output of the chiller was stopped and the set temperature of the second heater was maintained at 100° C. The first heater and the first temperature sensor were placed in the outer region of the barrel. The second heater was placed in the inner region of the barrel. As the first temperature sensor, a thermocouple was used. As the material, MIM was used.

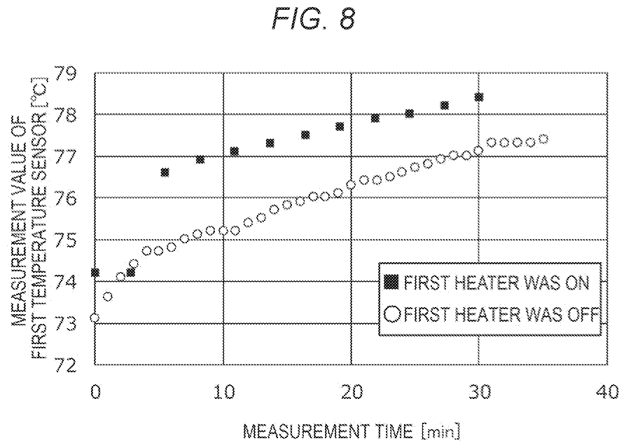

FIG. 8 is a graph showing a relationship between the measurement time and the measurement value of the first temperature sensor. The time when the output of the chiller was stopped was defined as a measurement time of 0. When the chiller was driven, the measurement value of the first temperature sensor was around 70° C., however, in this experimental example, the chiller was stopped, and therefore, as shown in FIG. 8, the measurement value of the first temperature sensor increased with the lapse of time.

In a state where the first heater was driven, backflow of the shaping material occurred in the flat screw before the temperature reached 80° C., and the material was brought into a state where all was melted. On the other hand, in a state where the output of the first heater was stopped, the increase in the measurement value of the first temperature sensor was gentler than in a state where the first heater was in a driven state. According to this experimental example, it was found that by stopping the output of the first heater, transition to a state where all the material is melted can be made slow.

The above-mentioned embodiments and modifications are examples, and the present disclosure is not limited thereto. For example, it is also possible to appropriately combine the individual embodiments and the individual modifications.

The present disclosure includes substantially the same configuration, for example, a configuration having the same function, method, and result, or a configuration having the same object and effect as the configuration described in the embodiments. Further, the present disclosure includes a configuration in which a part that is not essential in the configuration described in the embodiments is substituted. Further, the present disclosure includes a configuration having the same operational effect as the configuration described in the embodiments, or a configuration capable of achieving the same object as the configuration described in the embodiments. In addition, the present disclosure includes a configuration in which a known technique is added to the configuration described in the embodiments.

From the above-mentioned embodiments, the following contents are derived.

One aspect of a three-dimensional shaping apparatus includes a plasticizing unit that plasticizes a material to form a shaping material, a nozzle that has a nozzle opening and ejects the shaping material, a stage at which the shaping material ejected from the nozzle is stacked, and a control unit that controls the plasticizing unit. The plasticizing unit includes a driving motor, a screw that is rotated by the driving motor and that has a grooved face having a groove formed therein, a barrel that has an opposed face opposed to the grooved face and that is provided with a communication hole, and a first heater that heats the material supplied between the screw and the barrel. The control unit performs a process of decreasing an output of the first heater when at least one of a first condition, a second condition, and a third condition is satisfied, provided that the first condition is that a measurement value of a first temperature sensor that measures a temperature of the screw or the barrel is larger than a first predetermined value, the second condition is that a torque value of the driving motor is smaller than a second predetermined value, and the third condition is that a measurement value of a pressure sensor that measures a pressure in a flow channel between the communication hole and the nozzle opening is smaller than a third predetermined value.

According to the three-dimensional shaping apparatus, the temperature between the flat screw and the barrel can be decreased. According to this, melting of all the material supplied between the flat screw and the barrel can be suppressed. As a result, a bridge phenomenon is suppressed, and stable plasticization can be achieved.

In one aspect of the three-dimensional shaping apparatus, the control unit may stop the output of the first heater in the process of decreasing the output of the first heater.

According to the three-dimensional shaping apparatus, the temperature between the flat screw and the barrel can be further decreased.

In one aspect of the three-dimensional shaping apparatus, the plasticizing unit may include a second heater provided nearer to the communication hole than the first heater.

According to the three-dimensional shaping apparatus, even if the output of the first heater is decreased, the temperature in the vicinity of the communication hole can be kept high by the second heater.

In one aspect of the three-dimensional shaping apparatus, after performing the process of decreasing the output of the first heater, the control unit may perform a process of stopping an output of the second heater when at least one of a fourth condition, a fifth condition, and a sixth condition is satisfied, provided that the fourth condition is that the measurement value of the first temperature sensor is larger than a fourth predetermined value, the fourth predetermined value is larger than the first predetermined value, the fifth condition is that the torque value of the driving motor is smaller than a fifth predetermined value, the fifth predetermined value is smaller than the second predetermined value, the sixth condition is that the measurement value of the pressure sensor is smaller than a sixth predetermined value, and the sixth predetermined value is smaller than the third predetermined value.

According to the three-dimensional shaping apparatus, the temperature between the flat screw and the barrel can be further decreased.

In one aspect of the three-dimensional shaping apparatus, the control unit may perform a process of stopping an output of the driving motor and generating an error signal when at least one of the fourth condition, the fifth condition, and the sixth condition is satisfied.

According to the three-dimensional shaping apparatus, a user can be notified that an error has occurred while reducing the amount of the material to be wasted.

In one aspect of the three-dimensional shaping apparatus, the first heater and the second heater may have a shape surrounding the communication hole.

According to the three-dimensional shaping apparatus, a temperature gradient such that the temperature gradually increases from the outer circumference of the barrel to the communication hole can be easily formed.

In one aspect of the three-dimensional shaping apparatus, the first temperature sensor may measure a temperature of an outer region nearer to the outer circumference of the barrel than to the communication hole.

According to the three-dimensional shaping apparatus, by monitoring the temperature measured with the first temperature sensor, the material can be prevented from being melted in the outer region of the barrel.

In one aspect of the three-dimensional shaping apparatus, the plasticizing unit may include a second temperature sensor that measures a temperature of an inner region nearer to the communication hole than to the outer circumference of the barrel. The control unit may control the first heater based on the measurement value of the first temperature sensor, and control the second heater based on the measurement value of the second temperature sensor.

According to the three-dimensional shaping apparatus, the control unit can independently control the first heater and the second heater.

In one aspect of the three-dimensional shaping apparatus, the first temperature sensor may be provided outside the first heater, and the second temperature sensor may be provided inside the second heater.

According to the three-dimensional shaping apparatus, the effect of the second heater on the first temperature sensor and the effect of the first heater on the second temperature sensor can be decreased.

In one aspect of the three-dimensional shaping apparatus, the first predetermined value, the second predetermined value, and the third predetermined value may vary depending on a type of the material.

According to the three-dimensional shaping apparatus, optimal values can be set for each material as the first predetermined value, the second predetermined value, and the third predetermined value.

One aspect of an injection molding apparatus includes a plasticizing unit that plasticizes a material to form a shaping material, a nozzle that has a nozzle opening and injects the shaping material supplied from the plasticizing unit to a mold, and a control unit that controls the plasticizing unit. The plasticizing unit includes a driving motor, a screw that is rotated by the driving motor and that has a grooved face having a groove formed therein, a barrel that has an opposed face opposed to the grooved face and that is provided with a communication hole, and a first heater that heats the material supplied between the screw and the barrel. The control unit performs a process of decreasing an output of the first heater when at least one of a first condition, a second condition, and a third condition is satisfied, provided that the first condition is that a measurement value of a first temperature sensor that measures a temperature of the screw or the barrel is larger than a first predetermined value, the second condition is that a torque value of the driving motor is smaller than a second predetermined value, and the third condition is that a measurement value of a pressure sensor that measures a pressure in a flow channel between the communication hole and the nozzle opening is smaller than a third predetermined value.

What is claimed is:

1. A three-dimensional shaping apparatus, comprising:
a plasticizing unit that plasticizes a material to form a shaping material;
a nozzle that has a nozzle opening and ejects the shaping material;
a stage at which the shaping material ejected from the nozzle is stacked; and
a control unit that controls the plasticizing unit, wherein
the plasticizing unit includes
a driving motor,
a screw that is rotated by the driving motor and that has a grooved face having a groove formed therein,
a barrel that has an opposed face opposed to the grooved face and that is provided with a communication hole, and
a first heater that heats the material supplied between the screw and the barrel, and
the control unit performs a process of decreasing an output of the first heater when at least one of a first condition, a second condition, and a third condition is satisfied, provided that
the first condition is that a measurement value of a first temperature sensor that measures a temperature of the screw or the barrel is larger than a first predetermined value,
the second condition is that a torque value of the driving motor is smaller than a second predetermined value, and
the third condition is that a measurement value of a pressure sensor that measures a pressure in a flow channel between the communication hole and the nozzle opening is smaller than a third predetermined value.

2. The three-dimensional shaping apparatus according to claim 1, wherein
the control unit stops the output of the first heater in the process of decreasing the output of the first heater.

3. The three-dimensional shaping apparatus according to claim 1, wherein
the plasticizing unit includes a second heater provided nearer to the communication hole than the first heater.

4. The three-dimensional shaping apparatus according to claim 3, wherein
after performing the process of decreasing the output of the first heater, the control unit performs a process of stopping an output of the second heater when at least one of a fourth condition, a fifth condition, and a sixth condition is satisfied, provided that
the fourth condition is that the measurement value of the first temperature sensor is larger than a fourth predetermined value,
the fourth predetermined value is larger than the first predetermined value,
the fifth condition is that the torque value of the driving motor is smaller than a fifth predetermined value,
the fifth predetermined value is smaller than the second predetermined value,
the sixth condition is that the measurement value of the pressure sensor is smaller than a sixth predetermined value, and
the sixth predetermined value is smaller than the third predetermined value.

5. The three-dimensional shaping apparatus according to claim 4, wherein
the control unit performs a process of stopping an output of the driving motor and generating an error signal when at least one of the fourth condition, the fifth condition, and the sixth condition is satisfied.

6. The three-dimensional shaping apparatus according to claim 3, wherein
the first heater and the second heater have a shape surrounding the communication hole.

7. The three-dimensional shaping apparatus according to claim 3, wherein
the first temperature sensor measures a temperature of an outer region nearer to an outer circumference of the barrel than to the communication hole.

8. The three-dimensional shaping apparatus according to claim 7, wherein
the plasticizing unit includes a second temperature sensor that measures a temperature of an inner region nearer to the communication hole than to the outer circumference of the barrel, and
the control unit
controls the first heater based on the measurement value of the first temperature sensor, and
controls the second heater based on the measurement value of the second temperature sensor.

9. The three-dimensional shaping apparatus according to claim 8, wherein
the first temperature sensor is provided outside the first heater, and
the second temperature sensor is provided inside the second heater.

10. The three-dimensional shaping apparatus according to claim 1, wherein the first predetermined value, the second predetermined value, and the third predetermined value vary depending on a type of the material.

11. An injection molding apparatus, comprising:
a plasticizing unit that plasticizes a material to form a shaping material;
a nozzle that has a nozzle opening and injects the shaping material supplied from the plasticizing unit to a mold; and
a control unit that controls the plasticizing unit, wherein
the plasticizing unit includes
a driving motor,
a screw that is rotated by the driving motor and that has a grooved face having a groove formed therein,
a barrel that has an opposed face opposed to the grooved face and that is provided with a communication hole, and
a first heater that heats the material supplied between the screw and the barrel, and
the control unit performs a process of decreasing an output of the first heater when at least one of a first condition, a second condition, and a third condition is satisfied, provided that
the first condition is that a measurement value of a first temperature sensor that measures a temperature of the screw or the barrel is larger than a first predetermined value,
the second condition is that a torque value of the driving motor is smaller than a second predetermined value, and
the third condition is that a measurement value of a pressure sensor that measures a pressure in a flow channel between the communication hole and the nozzle opening is smaller than a third predetermined value.
